(19) United States
(12) Patent Application Publication
(10) Pub. No.: US 2026/0279624 A1
(43) Pub. Date: Sep. 17, 2026

(54) PTC RESISTOR

(71) Applicant: TOKYO COSMOS ELECTRIC CO., LTD., Kanagawa (JP)

(72) Inventors: Hajime MIYAHARA, Kanagawa (JP); Hironori ITO, Kanagawa (JP)

(21) Appl. No.: 19/166,742

(22) PCT Filed: Mar. 4, 2024
(86) PCT No.: PCT/JP2024/007955

§ 371 Date: Sep. 18, 2025

(30) Foreign Application Priority Data
Mar. 23, 2023 (JP) 2023-046587

(51) Int. Cl. H01C 7/02; H05B 3/14

(52) U.S. Cl. CPC H01C 7/027; H01C 7/028; H05B 3/146; H05B 2203/02

(57) ABSTRACT

The present invention addresses the problem of providing a PTC resistor wherein the resistance value is easily increased within a short time after reaching a certain temperature and the resistance value after temperature increase is high. A PTC resistor according to the present invention, which solves the above-described problem, comprises conductive particles, a polyolefin-based wax and a binder resin. With respect to the DSC curve of the polyolefin-based wax as obtained by raising the temperature from 25° C. to 150° C. at a heating rate of 10° C./min using a differential scanning calorimeter, the number of melting peaks found in the DSC curve is 1 or 2.

### TECHNICAL FIELD

The present disclosure relates to a PTC resistor.

### BACKGROUND ART

To remove frost or dew adhering to a door mirror of an automobile or the like, a heater may be installed on the back surface of the mirror. A planar heating element having positive temperature coefficient (PTC) characteristics, which does not require an expensive temperature control apparatus, is widely used as such a heater.

A planar heating element having PTC characteristics typically includes a pair of electrodes and a resistor having PTC characteristics (also referred to as a “PTC resistor” in the present specification) disposed between the electrodes. A resistor including a crystalline resin and conductive particles is known as the PTC resistor (for example, PTL 1). In the planar heating element including such a PTC resistor, when a voltage is applied between the electrodes, electricity is conducted through the PTC resistor, causing its temperature to rise. Meanwhile, as the temperature of the planar heating element (PTC resistor) rises, the crystalline resin included therein thermally expands, widening the distance between the conductive particles and increasing the resistance value. The resistance value then rapidly increases near the softening temperature or the melting point of the crystalline resin, making it difficult for electricity to be conducted. Therefore, in the planar heating element, the temperature is controlled not to increase to a certain level or higher.

### CITATION LIST

### Patent Literature

PTL 1

Japanese Patent Application Laid-Open No. 2012-227081

### SUMMARY OF INVENTION

### Technical Problem

Conventionally known PTC resistors using a crystalline resin as the binder have had the problem such that the thermal expansion during temperature rise is still not sufficient, and even when the temperature reaches a certain temperature, it takes time for the resistance value to increase. In addition, it is also required to further increase the resistance value of the PTC resistor after the temperature rise.

An object of the present disclosure is to provide a PTC resistor whose resistance value increases in a short time after the temperature of the PTC resistor reaches a certain temperature, and whose resistance value after the temperature rise is high.

### Solution to Problem

An embodiment of the present disclosure provides a PTC resistor that includes: a conductive particle; a polyolefin-based wax; and a binder resin, in which the polyolefin-based wax has one or two melting peaks observed in a DSC curve obtained by increasing a temperature of the polyolefin-based wax at a temperature rising rate of 10° C./min from 25° C. to 150° C. using a differential scanning calorimeter.

### Advantageous Effects of Invention

The present disclosure can obtain a PTC resistor whose resistance value increases in a short time after the temperature of the PTC resistor reaches a certain temperature, and whose resistance value after the temperature rise is high.

### BRIEF DESCRIPTION OF DRAWINGS

FIG. 1A is the DSC curve of a polyolefin-based wax used in Example 1 and Example 2, and FIG. 1B is the DSC curve of an ultra-high molecular weight polyethylene used in Comparative Example 2 and Comparative Example 3.

### DESCRIPTION OF EMBODIMENTS

In the present specification, a numerical range indicated by “to” means a numerical range including the numerical values indicated before and after “to”.

As described above, in a conventional PTC resistor, the PTC characteristics are imparted by mainly using thermal expansion or recrystallization of the crystalline resin. However, with the method, the rate of increase in the resistance value after the temperature reaches a certain temperature is low, and the degree of increase in the resistance value is also small. A PTC resistor according to the present disclosure meanwhile contains a specific polyolefin-based wax in addition to conductive particles and a binder resin. In the PTC resistor, the polyolefin-based wax melts in the vicinity of the melting point thereof when the temperature rises. The volume increase due to the melting of the polyolefin-based wax is significantly larger than the volume increase of a general resin.

In addition, the polyolefin-based wax has one or two melting peaks observed in a DSC curve obtained by increasing the temperature of the wax at a temperature rising rate of 10° C./min from 25° C. to 150° C. using a differential scanning calorimeter (hereinafter, also referred to as “DSC”). A small number of melting peaks in the DSC curve indicates a very small amount of impurities, and means that the polyolefin-based wax melts in a short time at the melting peak temperature. Therefore, in a PTC resistor containing the polyolefin-based wax, when the temperature of the PTC resistor rises, the polyolefin-based wax melts at the melting peak temperature thereof in a short time, and the resistance value is greatly increased in a short time. PTC resistors having such excellent PTC characteristics can be suitably used for various planar heating elements and the like. Hereinafter, each component in the PTC resistor according to the present disclosure will be described.

### (Polyolefin-Based Wax)

In the present specification, the wax refers to an organic substance that is solid or semi-solid at room temperature and melts without decomposing by heating. In addition, the polyolefin-based wax refers to a wax containing 50% by mass or more of a component derived from an olefin. The polyolefin-based wax used in the present disclosure is such that the number of melting peaks observed in a DSC curve obtained by increasing the temperature of the wax at a temperature rising rate of 10° C./min from 25° C. to 150° C. using a DSC is one or two. The number of melting peaks observed is more preferably one. In the present specification, the melting peak in a DSC curve refers to an endothermic peak having an absolute value of a peak height of 0.5 mW or more, and does not include noise having a height of less than 0.5 mW. In the present specification, all of the DSC curves are values acquired by using 5 mg of sample.

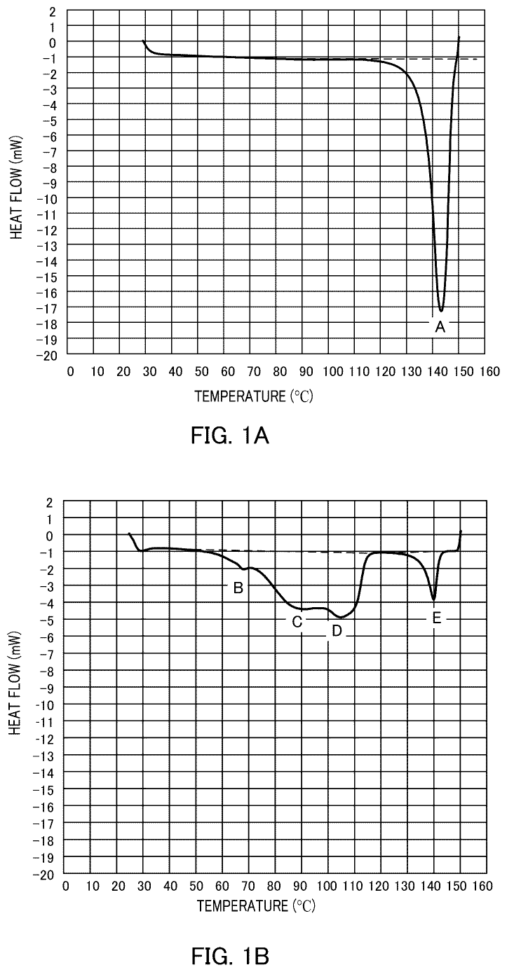

In the present specification, the peak height is a value obtained as follows. First, in a DSC curve, the falling position and rising position of the line in a downward convex region (region where an endothermic reaction occurs) are identified. When both of these positions can be identified, these positions are connected by a line, and this line is used as a baseline. In the present specification, the baseline is drawn only for a large mountain-shaped region where the rise and fall exceed 1 mW. For example, as illustrated in FIG. 1B, when one large mountain-shaped region (downward convex region) includes small peaks (B, C, and D) each having a rise or fall of 1 mW or less, only one baseline is drawn for the large mountain-shaped region. In addition, as illustrated in FIG. 1B, when there are two or more large mountain-shaped regions (downward convex regions), the baseline is drawn for each of the large mountain-shaped regions (two baselines in FIG. 1B). On the other hand, as illustrated in FIG. 1A, when either the falling position or rising position of the line in a downward convex region cannot be identified, the baseline is drawn in a straight line along the bottom of the position where the falling or rising can be identified.

From each peak top (A in FIG. 1A, or B, C, D, or E in FIG. 1B) of the melting peak in the DSC curve, a line perpendicular to the X-axis is then drawn, and the distance from the intersection of the perpendicular line and the baseline to the peak top is defined as the height of each peak.

The absolute value of a melting peak height in the DSC curve obtained by the above-described method is preferably 5 mW or more. When the absolute value of a melting peak height is 5 mW or more, a large amount of polyolefin-based wax is easily melted at the melting peak temperature. When there are two melting peaks in the DSC curve, the absolute value of the height of either one of the melting peaks may be 5 mW or more.

In addition, the melting peak of the polyolefin-based wax in the DSC curve is preferably in a range of 80° C. or higher and 150° C. or lower, more preferably in a range of 90° C. or higher and 140° C. or lower, and still more preferably in a range of 100° C. or higher and 130° C. or lower. In this manner, a PTC resistor exhibiting an increase in resistance value at 80° C. or higher and 150° C. or lower can be obtained.

The weight-average molecular weight of the polyolefin-based wax is preferably 1,000 or more and 1,500,000 or less, and more preferably 3,000 or more and 20,000 or less. When the weight-average molecular weight of the polyolefin-based wax is in the range, it is more likely to have a melting peak within the above temperature range. The weight-average molecular weight is a polystyrene equivalent value measured by gel permeation chromatography (GPC).

The PTC resistor may include only one type of polyolefin-based wax or two or more types thereof. Examples of the polyolefin-based wax include homopolymers of olefins, copolymers of two or more types of olefins, and copolymers of olefins and More specific examples of the polyolefin wax include monomers other than olefins. polyethylene waxes such as low-density polyethylene wax, medium-density polyethylene wax, and high-density polyethylene wax, polypropylene wax, polybutene wax, ethylene-propylene copolymer wax, and ethylene-propylene-butene copolymer wax. In addition, an oxidized polyolefin-based wax obtained by oxidizing any one of these by a known method may also be used. Among these, from the viewpoint of availability, PTC characteristics, and the like, a polyethylene-based wax is preferable.

The content of the polyolefin-based wax in the PTC resistor is preferably 6% by mass or more and 24% by mass or less, and more preferably 12% by mass or more and 20% by mass or less. When the content of the polyolefin-based wax in the PTC resistor is 6% by mass or more, the PTC ratio of the PTC resistor is further increased, or after the temperature of the PTC resistor rises to reach a certain temperature, the rate of increase in the resistance value is further increased. On the other hand, when the content is 24% by mass or less, the amount of the conductive particles becomes relatively and sufficiently large, and the PTC characteristics are more likely to be further improved.

### (Binder Resin)

The binder resin may be any resin as long as it can bind the above-described polyolefin-based wax and conductive particles described below to each other or bind these components to a substrate or the like. The binder resin is preferably a resin that does not hinder the volume change upon melting of the above-described polyolefin-based wax. In addition, the binder resin itself may also expand by the temperature rise to contribute to the increase in the resistance value of the PTC resistor. The PTC resistor may contain only one type of binder resin or two or more types thereof.

Examples of the binder resin include known thermoplastic resins. Specific examples the binder resin include thermoplastic polyurethane resins, polyester resins, polyacrylate resins, polysiloxane resins, halogenated vinyl resins, vinylidene resins, polyimide resins, phenoxy resins, polyether resins, polyketone resins, polyvinyl butyral resins, polyvinylpyrrolidone resins, polyacrylate resins, SEBS resins (styrene-ethylene-butylene-styrene copolymers) and hydrogenated products thereof, SEPS resins (styrene-ethylene-propylene-styrene copolymers) and hydrogenated products thereof, and the like. Among these, from the viewpoint of easily being deformable and not hindering the volume change of the above-described polyolefin-based wax, a SEBS resin and a hydrogenated SEPS resin are preferable.

The amount of the binder resin in the PTC resistor is preferably 6% by mass or more and 30% by mass or less, and more preferably 15% by mass or more and 28% by mass or less. When the amount of the binder resin in the PTC resistor is 6% by mass or more, it becomes easier to print the composition containing a conductive resin, the polyolefin-based wax, and the binder resin, or the fixing property after printing is improved. Further, the strength of the PTC resistor is also more likely to be further increased. On the other hand, when the amount of the binder resin is 30% by mass or less, the amount of the conductive particles becomes relatively and sufficiently large, and the PTC characteristics are more likely to be further improved.

### (Conductive Particles)

The conductive particles may be any particles as long as the particles are conductive, but particles having a thermal expansion coefficient of 20×10⁻⁶/° C. or less are preferable, and particles having a thermal expansion coefficient of 6.0×10⁻⁶/° C. or less are more preferable. The thermal expansion coefficient of conductive particles can be specified from the material of the conductive particles. The PTC resistor may include only one type of conductive particles or two or more types of conductive particles.

Examples of the conductive particles include carbon-based particles such as graphite, carbon black, carbon nanotubes, and graphene; and metal-based particles such as nickel powder, copper powder, silver powder, and tungsten powder. Among these, nickel powder, silver powder, tungsten powder, and graphite are preferable from the viewpoint of having high affinity with the above-described polyolefin-based wax, the binder resin, or the like and being difficult to precipitate in a composition for manufacturing the PTC resistor.

In addition, the conductive particles may have any shape, and for example, the conductive particles may be spherical, irregular, tubular, rod-shaped, flat, or crushed. The specific surface area of the conductive particles is preferably 5 m²/g or less. The specific surface area is a value measured by a gas adsorption method.

The size of the conductive particles is appropriately selected according to the type of conductive particles or the like. For example, when the conductive particles are spherical or substantially spherical, the average particle diameter thereof is preferably 30 μm or less, and more preferably 1 μm or more and 10 μm or less. When the average particle diameter is 30 μm or less, the PTC ratio of the PTC resistor is more likely to be further improved. The average particle diameter is a value measured by a laser diffraction and scattering method and is a median value (D50) in a cumulative particle size distribution.

The content of the conductive particles in the PTC resistor is preferably 45% by mass or more and 80% by mass or less, more preferably 50% by mass or more and 70% by mass or less, and still more preferably 55% by mass or more and 67.5% by mass or less. When the amount of the conductive particles in the PTC resistor is 45% by mass or more, the PTC characteristics are more likely to become more stable. On the other hand, when the amount of the conductive particles in the PTC resistor is 80% by mass or less, the amounts of the polyolefin-based wax and the binder resin increase, and the resistance value is more likely to increase further when the temperature is increased.

### (Others)

The PTC resistor may include other components as necessary in addition to the polyolefin-based wax, the binder resin, and the conductive particles, as long as the object and the effects of the present disclosure are not impaired. Examples of the other components include various additives such as antioxidants and flame retardants.

### (Method for Manufacturing PTC Resistor)

The PTC resistor of the present disclosure can be manufactured by applying a composition containing the polyolefin-based wax, the binder resin, the conductive particles, and, as necessary, a solvent, and heating and curing the composition.

The type of solvent is not limited as long as the polyolefin-based wax, the binder resin, the conductive particles, or the like described above can be uniformly dissolved or dispersed in the solvent. However, the boiling point of the solvent is preferably 100° C. or higher, more preferably 100° C. to 330° C., and still more preferably 150° C. to 250° C. When the boiling point of the solvent is within the range, the storage stability of the composition and the like are improved, and further, the composition is easier to apply.

The solvent is appropriately selected according to the type of polyolefin-based wax, the type of binder resin, and the like. Examples of the solvent include alcohols, ketones, esters, glycol esters, glycol ethers, ethers, aromatic hydrocarbons, and mixtures thereof. Terpineol, butyl carbitol acetate, tetralin, toluene, and mixtures thereof are preferable.

The amount of the solvent is appropriately selected according to the desired viscosity and the like of the composition, but is usually preferably about 20 to 70 parts by mass, and more preferably, 25 to 65 parts by mass based on 100 parts by mass of the total amount of the composition (ink). When the amount of the solvent is within the range, the viscosity of the composition (ink) is more likely to fall within the desired range.

The preferred viscosity of the composition is appropriately selected depending on the method for forming the PTC resistor. For example, when the composition is printed by screen printing and is cured to obtain a PTC resistor, the viscosity of the composition is preferably 100 to 400 dPa-s. The viscosity is a value measured at 25° C. with a cylindrical type rotational viscometer (manufactured by RION Co., Ltd.). When the viscosity of the composition is within the range, the composition can be applied to a desired thickness, and a film can be formed uniformly.

The method for preparing the composition is not limited, and the polyolefin-based wax, the resin binder, the conductive particles, and the solvent may be mixed at once. On the other hand, the resin binder and the solvent may be mixed first, and the polyolefin-based wax and the conductive particles may be mixed thereafter.

The method for applying the composition is not limited, and examples thereof include screen printing, roll coating, and application using a dispenser.

In addition, examples of the method for curing the composition include a method for heating the composition to about 100° C. to 200° C. In this case, the heating time is preferably about 1 to 30 minutes. When the composition is heated to the above-described degree, the solvent in the composition is removed.

### (Usage of PTC Resistor)

The PTC resistor can be used as a planar heating element, for example, in combination with a pair of electrodes. When the temperature of the PTC resistor is increased to exceed a certain temperature, the resistance value thereof is increased in a short time, and the resistance value is extremely high as compared with the resistance value at normal temperature (25° C.). Therefore, the PTC resistor can be used for various usage. For example, the PTC resistor can be used as a heater such as an anti-fogging heater for a door mirror of an automobile, a defogging heater for an in-vehicle camera of an automobile rear-end collision prevention apparatus, a defogging heater for an in-vehicle millimeter wave radar of an automobile rear-end collision prevention apparatus, an antenna cover, a thermistor, a heater for preventing freezing of a pipeline, a floor heating system, a heating seat of a chair, and a handrail heating seat.

### EXAMPLES

Hereinafter, specific examples of the present invention will be described. It is noted that the scope of the present invention is not limited to these examples.

### 1. Preparation of Materials

The following compounds were prepared as materials for producing a PTC resistor.

### (Polyolefin-Based Component)

Polyethylene wax (CERAFLUOR 961, manufactured by BYK)
Ultra-high molecular weight polyethylene (Mipelon PM-200, manufactured by Mitsui Chemicals, Inc.)

### (Binder Resin)

SEBS resin (styrene-ethylene-butylene-styrene block copolymer, Tuftec 1913, manufactured by Asahi Kasei Corporation)
Hydrogenated SEPS resin (hydrogenated styrene-ethylene-propylene-styrene block copolymer, SEPTON 2002, manufactured by Kuraray Co., Ltd.)

### (Conductive Particles)

PWSH: crushed carbon (manufactured by Long Time Technology Co., Ltd., graphite)
PG11: spherical carbon (manufactured by Long Time Technology Co., Ltd., graphite)
ICB: spherical carbon (manufactured by Nippon Carbon Co., Ltd., graphite)

For the above-described polyolefin-based components, a DSC curve in a range of 25° C. to 150° C. was acquired at a temperature rising rate of 10° C./min by DSC. The number of melting peaks and the absolute value of the height of the melting peak(s) at this time were specified. These results are shown in Table 1. In addition, FIG. 1A illustrates the DSC curve of the polyethylene wax used in Examples 1 and 2, and FIG. 1B illustrates the DSC curve of the ultra-high molecular weight polyethylene used in Comparative Examples 2 and 3.

The average particle diameter D50 of the above-described conductive particles was measured by a laser diffraction and scattering method. In addition, the literature value was used as the thermal expansion coefficient. Furthermore, the specific surface area was measured by a gas adsorption method. These results are shown in Table 1.

### 2. Production of Planar Heating Element Including PTC Resistor

A planar heating element including each PTC resistor was produced by the following procedure.

### Example 1

A varnish was prepared by mixing 8.0 parts by mass of the hydrogenated SEPS resin and 51.0 parts by mass of an organic solvent (terpineol) at 100° C. for 1 hour with a stirrer. The varnish, 9.0 parts by mass of a polyolefin-based wax (polyethylene wax), and 32.0 parts by mass of conductive particles (spherical carbon) were mixed and ground with a stirring grinding mixer to obtain an ink for screen printing.

A substrate including a pair of comb-shaped electrodes was prepared, and the above-described ink was printed between the comb-shaped electrodes by screen printing. The substrate was heated to 150° C. to produce a planar heating element including a desired PTC resistor.

### Comparative Example 1

A planar heating element including a PTC resistor was produced in the same manner as in Example 1, except that a paste was produced with the composition shown in Table 1 without using a polyolefin-based wax.

### Example 2 and Comparative Examples 2 and 3

Planar heating elements each including a PTC resistor were produced in the same manner as in Example 1, except that the organic solvent and the type and amount of each component were changed as shown in Table 1.

### [Evaluation]

The following tests were performed on the planar heating elements produced in Examples 1 and 2 and Comparative Examples 1 to 3. The results are shown in Table 1.

### (Temperature Rising Rate Measurement)

The temperature of the planar heating element was increased in a room temperature environment (25° C.), and a temperature at which the temperature was stabilized and the time taken to reach the stabilized temperature were specified. The temperature rising rate was determined by the following expression.

### (Stable Temperature-Initial Temperature)/(Time to Stabilize)

### (Plane Resistance Measurement)

The plane resistance of each planar heating element was measured by a two-terminal method or a four-terminal method.

### (Specifying of Maximum PTC Ratio)

The resistance value of each planar heating element when the temperature is increased from −40° C. to 120° C. was measured. The maximum resistance value and the minimum resistance value were then specified, and the ratio (maximum resistance value/minimum resistance value) thereof was calculated as the maximum PTC ratio. The measurement of each resistance value was performed by a two-terminal method or a four-terminal method.

### (Specifying of Maximum PTC Ratio in Room Temperature Environment)

The resistance value of the planar heating element at 25° C. immediately after its manufacture was measured. Next, the temperature of the planar heating element was changed from −40° C. to 120° C., and then returned to 25° C. to measure the resistance value again. Then, the ratio (resistance value at 25° C. after the temperature change/resistance value at 25° C. before the temperature change) thereof was calculated as the maximum PTC ratio in the room temperature environment.

### (Determination)

When the maximum PTC ratio was 100 times or more, it was determined as ∘, and when the maximum PTC ratio was less than 100 times, it was determined as x.

TABLE 1

| | | | Comp. | | | Comp. | Comp. |
|---|---|---|---|---|---|---|---|
| | | | Ex. 1 | Ex. 1 | Ex. 2 | Ex. 2 | Ex. 3 |
| Composition | Solvent | Type | Butyl | Terpineol | Butyl | Terpineol | Butyl |
| | | | carbitol | | carbitol | | carbitol |
| | | | acetate | | acetate | | acetate |
| | | Amount | 49.3 | 51.0 | 51.0 | 61.3 | 28.9 |
| | | (parts by | | | | | |
| | | mass) | | | | | |
| | Binder | Type | SEBS | Hydrogenated | SEBS | SEBS | SEBS |
| | resin | | | SEPS | | | |
| | | Amount | 20.8 | 8.0 | 14.0 | 10.4 | 14.4 |
| | | (parts by | | | | | |
| | | mass) | | | | | |
| | Polyolefin- | Type | — | Polyethylene | Polyethylene | Ultra-high | Ultra-high |
| | based | | | wax | wax | molecular | molecular |
| | component | | | | | weight | weight |
| | | | | | | polyethylene | polyethylene |
| | | Number of | — | 1 | 1 | 4 | 4 |
| | | melting | | | | | |
| | | peaks | | | | | |

| | | | | | | | | | |
|---|---|---|---|---|---|---|---|---|---|
| Height of | — | 17 | mW | 17 | mW | 4 | mW | 4 | mW |

| | | | | | | |
|---|---|---|---|---|---|---|
| | melting | | | | | |
| | peaks | | | | | |
| | Weight- | — | 5500 | 5500 | 1800000 | 1800000 |
| | average | | | | | |
| | molecular | | | | | |
| | weight | | | | | |
| | Amount | — | 9.0 | 9.0 | 7.0 | 10 |
| | (parts by | | | | | |
| | mass) | | | | | |
| Conductive | Type | PWSH | PG11 | ICB | PWSH | PG11 |
| particles | Shape | Crushed | Spherical | Spherical | Crushed | Spherical |

| | | | | | | | | | |
|---|---|---|---|---|---|---|---|---|---|
| Particle | 8 to 12 | μm | 9 to 13 | μm | 4 to 8 | μm | 9 to 13 | μm | 25 μm |

| | | | | | |
|---|---|---|---|---|---|
| diameter | | | | | or less |
| D50 | | | | | |
| Specific | 1.2 m²/g | 1.5 m²/g | 1.0 m²/g | 1.5 m²/g | 1.2 m²/g |
| surface | or less | or less | or less | or less | or less |
| area | | | | | |
| Amount | 29.8 | 32.0 | 32.0 | 21.3 | 46.7 |
| (parts by | | | | | |
| mass) | | | | | |

| | | | | | | | | | | |
|---|---|---|---|---|---|---|---|---|---|---|
| Temperature rising rate | 0.5° | C./sec | 2.5° | C./sec | 2.5° | C./sec | 0.8° | C./sec | 0.5° | C./sec |

| | | | | | |
|---|---|---|---|---|---|
| Plane resistance (kΩ/□) | 5 | 5 | 1.4 | 0.9 | 0.7 |
| Maximum PTC ratio | 20 | 8.1 × 10⁵ | 1.1 × 10⁵ | 40 | 5.6 |
| (−40° C. or more 120° C. or less) | | | | | |
| Maximum PTC ratio in room | 1.8 | 1 | 1 | 1 | 1 |
| temperature environment | | | | | |
| (after temperature rise) | | | | | |
| Determination | x | ∘ | ∘ | x | x |

As shown in the above table, in the planar heating elements using the PTC resistor including the polyolefin-based wax (Examples 1 and 2), the maximum PTC ratio was extremely high, and the temperature rising rate was also high as compared with the planar heating elements using the PTC resistor not including the polyolefin-based wax (Comparative Examples 1 to 3).

The present application is entitled to and claims the benefit of Japanese Patent Application No. 2023-046587, filed on Mar. 23, 2023, the disclosure of which including the specification and drawing is incorporated herein by reference in its entirety.

### INDUSTRIAL APPLICABILITY

The PTC resistor of the present disclosure has a resistance value that increases in a short time after the temperature of the PTC resistor reaches a certain temperature, and the resistance value is high after the temperature rise. Therefore, the PTC resistor is very useful for manufacturing various planar heating elements.

1. A PTC resistor comprising:
a conductive particle;
a polyolefin-based wax; and
a binder resin, wherein
the polyolefin-based wax has one or two melting peaks observed in a DSC curve obtained by increasing a temperature of the polyolefin-based wax at a temperature rising rate of 10° C./min from 25° C. to 150° C. using a differential scanning calorimeter.

2. The PTC resistor according to claim 1, wherein
an absolute value of a height of at least one of the melting peaks in the DSC curve is 5 mW or more.

3. The PTC resistor according to claim 1, wherein
the conductive particle has a thermal expansion coefficient of 20×10⁻⁶/° C. or less.

4. The PTC resistor according to claim 1, wherein
the conductive particle has an average particle diameter of 30 μm or less.

5. The PTC resistor according to claim 1, wherein
the conductive particle has a specific surface area of 5 m²/g or less.
